(19) United States
(12) Patent Application Publication
(10) Pub. No.: US 2007/0163158 A1
(43) Pub. Date: Jul. 19, 2007

(54) Shields and billboards

(76) Inventor: William George Bentz, Laurel, MD (US)

Correspondence Address: William G. Bentz, 8106 Shannon's Alley, Laurel, MD, 20724, US

(21) Appl. No.: 11/332,876

(22) Filed: Jan. 17, 2006

(51) Int. Cl. G09F 3/00

(52) U.S. Cl. 40/329

(57) ABSTRACT

One embodiment of a method may generate funds for one or more organizations by at least allowing one or more advertisers and/or sponsors to turn one or more sports helmet shields into one or more mobile billboards.

### FIELD OF THE INVENTION

One or more embodiments of the present invention relates in general to at least one of (i) gear such as, for example, a visor shield, a face shield, a disposable lens, a jaw pad and/or a bumper and (ii) one or more marketing and/or find raising programs that, for example, turn the gear into one or more billboards.

### DESCRIPTION OF BACKGROUND INFORMATION

Currently, Oakley makes and sells a face shield to be used by football players to prevent eye injuries. The Oakley face shield, when mounted to a football helmet, surrounds a substantial portion of a football player's face, particularly surrounding the nose and the cheeks, as described and illustrated in U.S. Pat. Nos. 5,815,848 and 6,038,705. The Oakley face shield has been used by some football players in the National Football League (“NFL”) and the National Collegiate Athletic Association (“NCAA”).

### BRIEF DESCRIPTION OF THE DRAWINGS

In the drawings, like reference numerals represent similar parts of the illustrated embodiments of the present invention throughout the several views and wherein:

FIGS. 1A, 1B, 1C and 1D depict exemplary embodiments of a face mask 122 mounted to a helmet 120;

FIGS. 2 and 6-8 depict exemplary embodiments of a visor shield 10 mounted to the face mask 122 and the helmet 120;

FIG. 3 depicts an exemplary embodiment of the face mask 122 of FIG. 2 and 6-8;

FIGS. 4, 5, 13 and 14 depict an exemplary embodiment of the visor shield 10 of FIGS. 2 and 6-8;

FIG. 9 depicts a cross-sectional view of the shield 10, 100 of FIGS. 4 and 10 taken along lines 4-4, illustrating a varying thickness of the shield 10, 100;

FIGS. 10, 11 13 and 14 depict an exemplary embodiment of the face shield 100;

FIGS. 12A and 12B depict exemplary embodiments of the face shield 100 of FIGS. 10 and 11 mounted to the face mask 122 and the helmet 120;

FIGS. 15 and 16 depict exemplary embodiments of a front bumper(s) 6 and a jaw pad(s) 5;

FIGS. 17 and 18 depict exemplary embodiments of bumpers 6, 7, 8 mounted to the helmet 120; and

FIG. 19 depicts exemplary embodiments of disposable lenses 202 mounted to the shield 10, 100.

### DETAILED DESCRIPTION

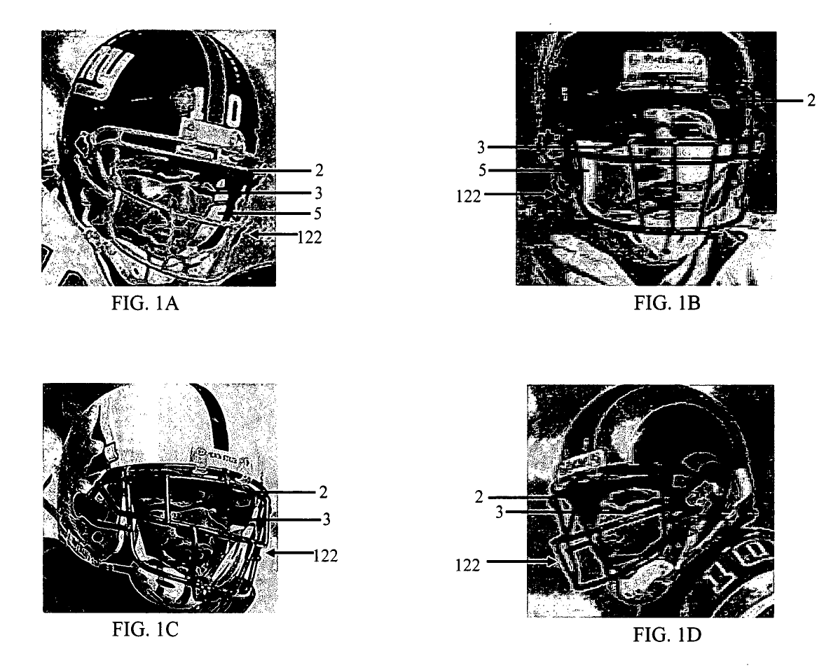

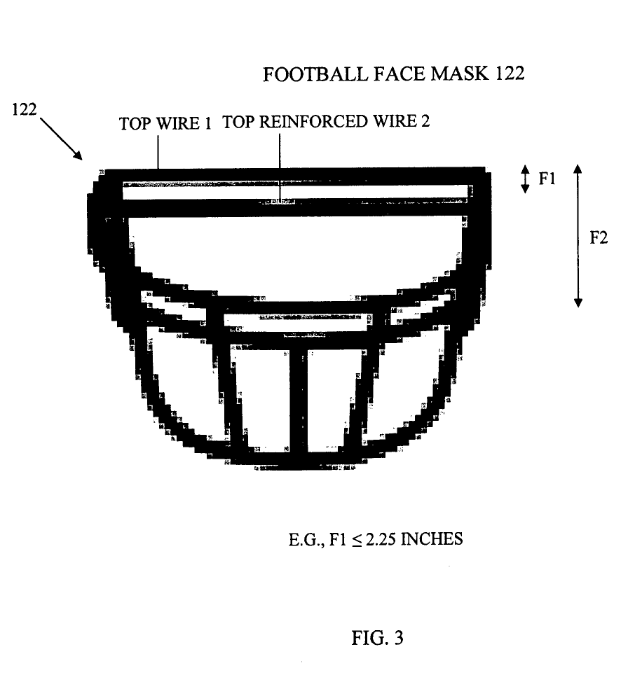

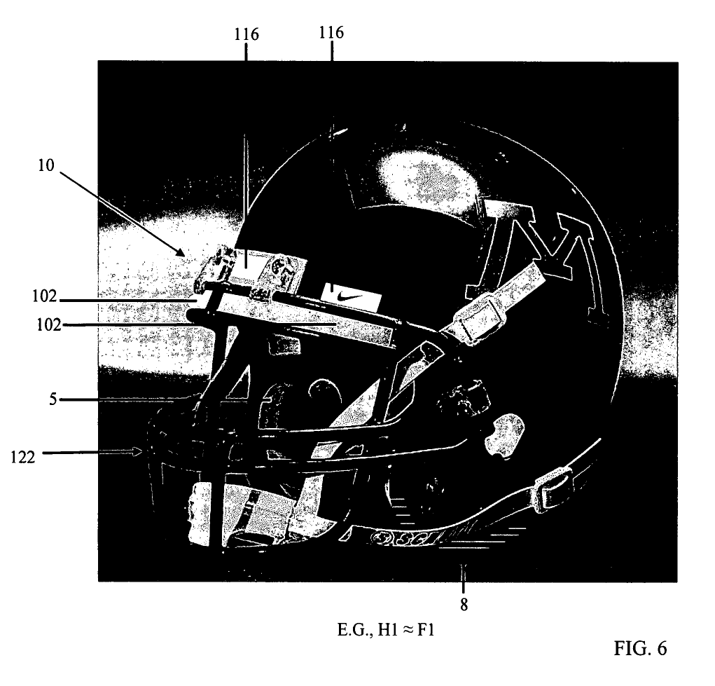

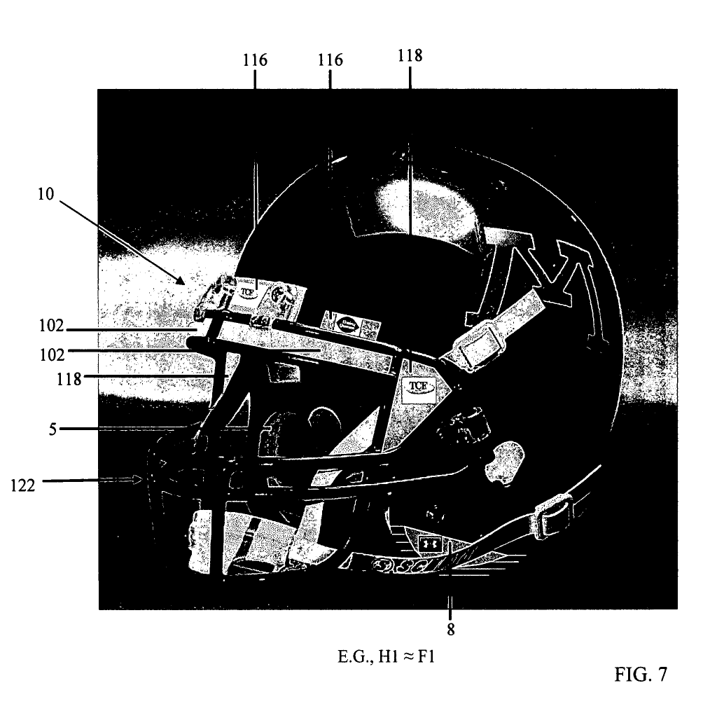

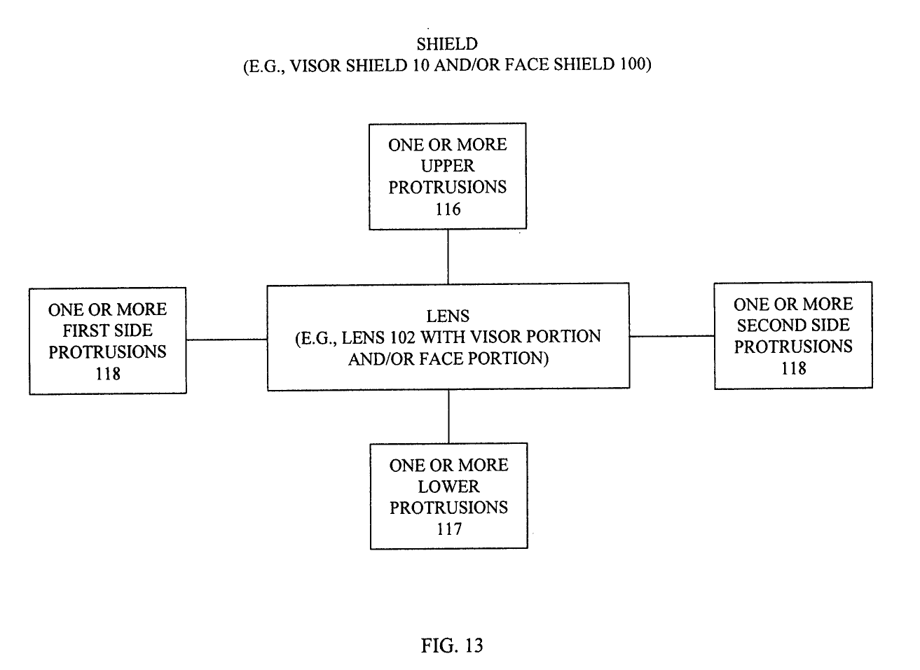

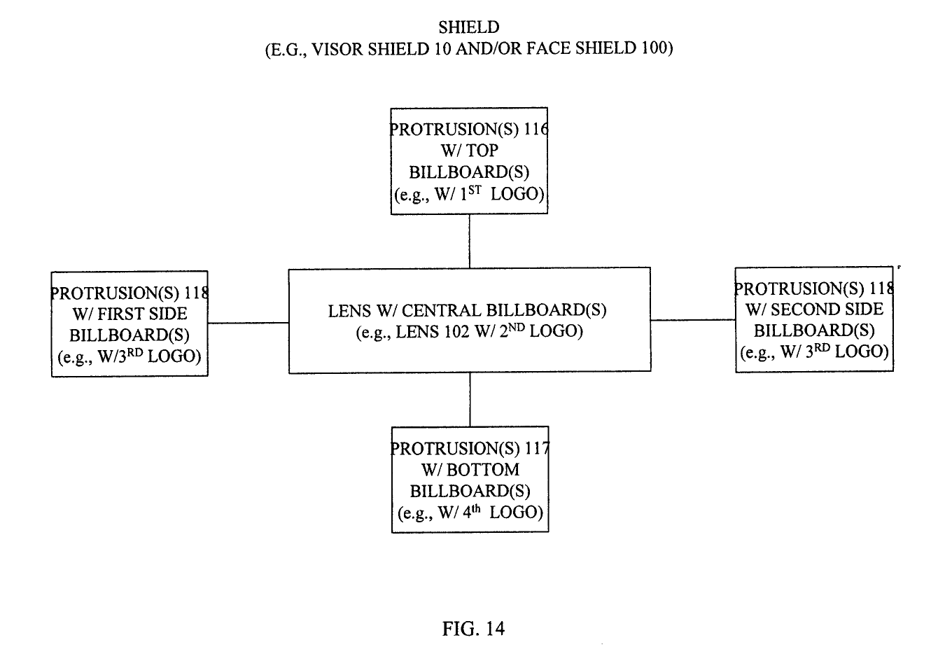

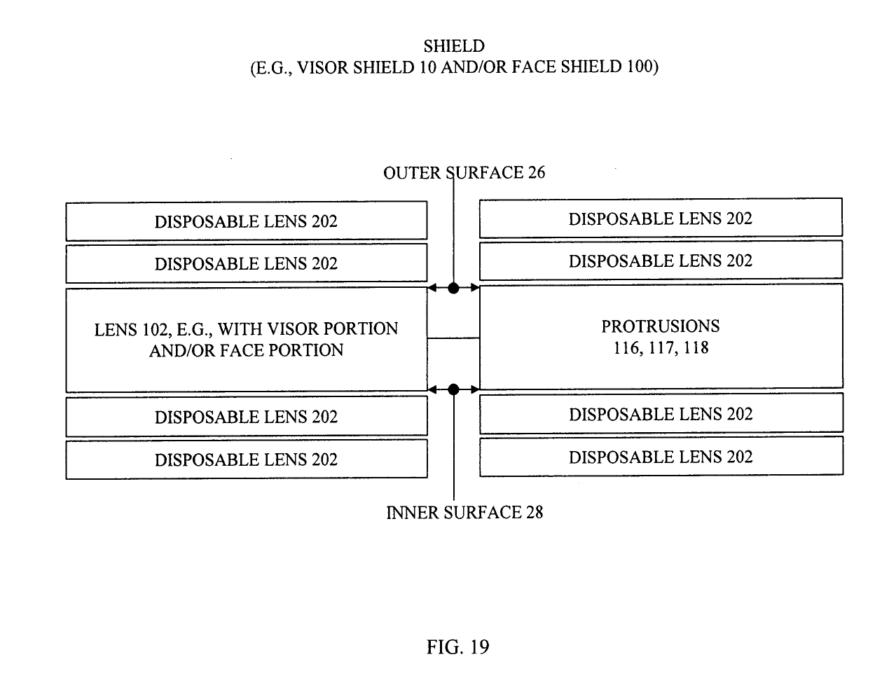

FIGS. 1-9, 13-14 and 19 illustrate one or more embodiments of a visor shield 10, and FIGS. 1, 3 9-14 and 19 illustrate one or more embodiments of a face shield 100. The shield 10, 100 may include a viewing window(s) and/or an advertisement window(s). The shield 10, 100 may also provide sunshade and/or antiglare protection, as the naked human eye is not capable of adapting quickly and effectively enough, for example, when encountering sun light and/or stadium lights.

The shield 10, 100 and/or other gear (e.g., disposable lenses 202, bumpers 6, 7, 8, jaw pads 5, etc.) may also be configured as an advertisement medium and/or billboard support to display images of one or more different types to provide advertising value to one or more surfaces of the gear. The billboard(s) may be static billboards and/or dynamic billboards. For example, the billboard(s) may include decals, one-way vision display panels (e.g., hologram film, perforated film, etc.), green screen and/or others.

The face shield 100 may include a top portion 104 (e.g., a visor portion) and a bottom portion 106 (e.g., a face portion). The visor portion 104 and the visor shield 10 may be of a first style (e.g., tinted and/or sunglasses), whereas the face portion 106 may be of a second style (e.g., clear and/or glasses). For example, the visor shield 10, the visor portion 104 and/or the face portion 106 may be styled as at least one of (i) 60% grey, (ii) 45% grey, (iii) 20% grey, (iv) blue, (v) bronze, (vi) clear, (vii) persimmon, (viii) vr28 and (ix) yellow. The shield 10, 100 may be, for example, a curved unitary lens(es).

The visor portion 104 and/or the visor shield 10 may, for example, provide sunshade and/or antiglare protection (i) when the head of a wearer is in an upright position and/or (ii) when the head is tilted forward to swivel the visor portion 104 and/or the visor shield 10 into his or her vertical field of vision.

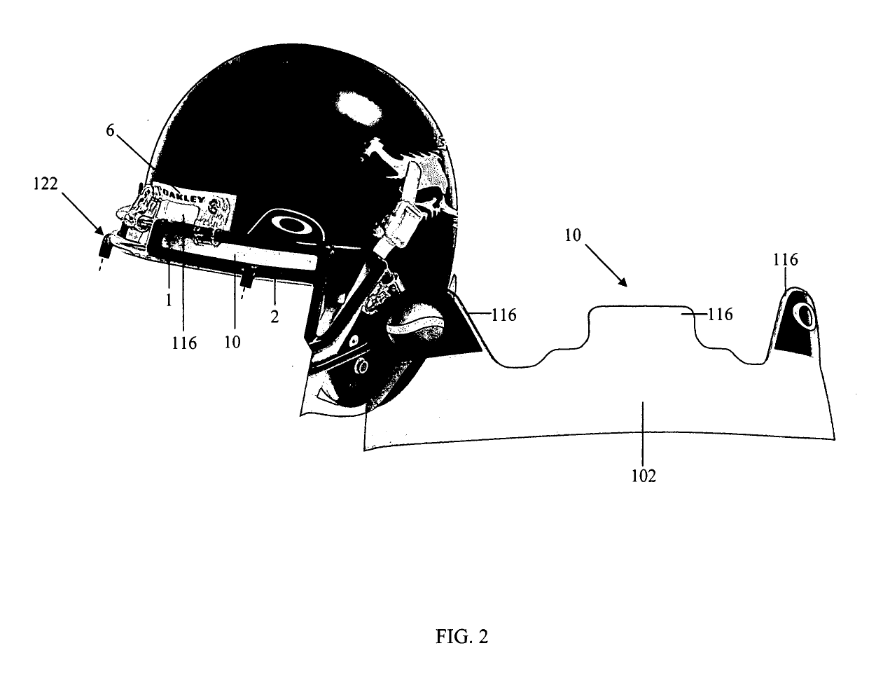

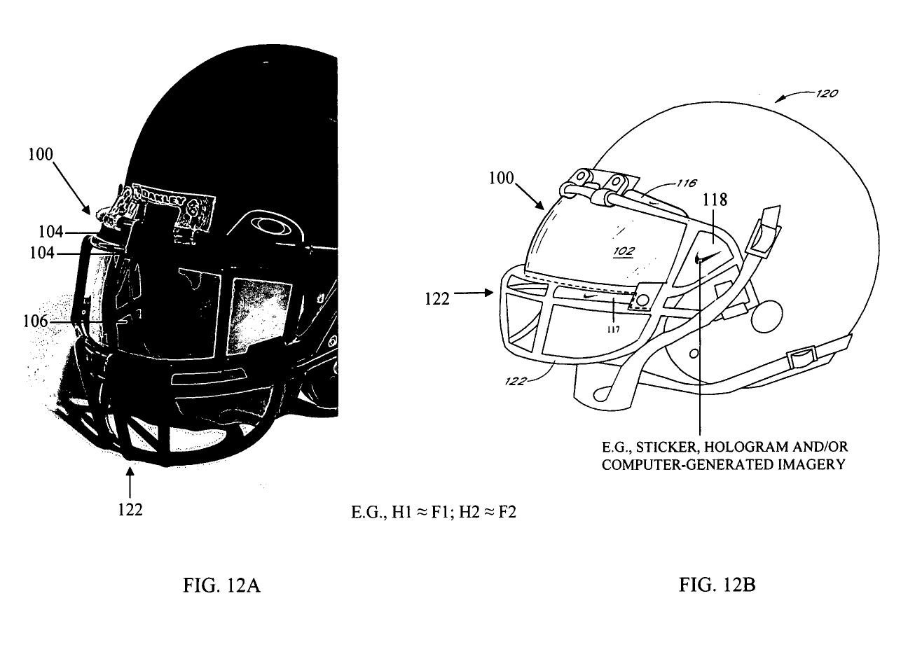

FIG. 1 illustrates a shadow 3 of a top reinforced wire 2 of a face mask 122. The visor shield 10, illustrated by FIG. 2, may allow football players to block direct light (e.g., sunlight and/or stadium lights), illustrated by FIG. 1, that interfere with their play, without having to hold their hands between their eyes and the direct light. The visor shield 10 may be used by football players that are not interested in the face shield 100, which may also include the visor portion 104, illustrated by FIG. 12A.

The shield 10, 100 may include a curved lens 102, which may be unitary and may be encompassed by a beaded frame 110 disposed about a periphery of the lens. The beaded frame 110 may be integrally molded with the lens 102 and may reinforce an edge of the shield and eliminate sharp contours. The visor portion 104 may be integrated to the face portion 106 to form a unitary lens 102. The visor portion 104 may also be embodied as a (e.g., self-stick) film and/or strip, for example, to attach to the shield 100. The visor portion 104 may also be removably attached to the shield 100.

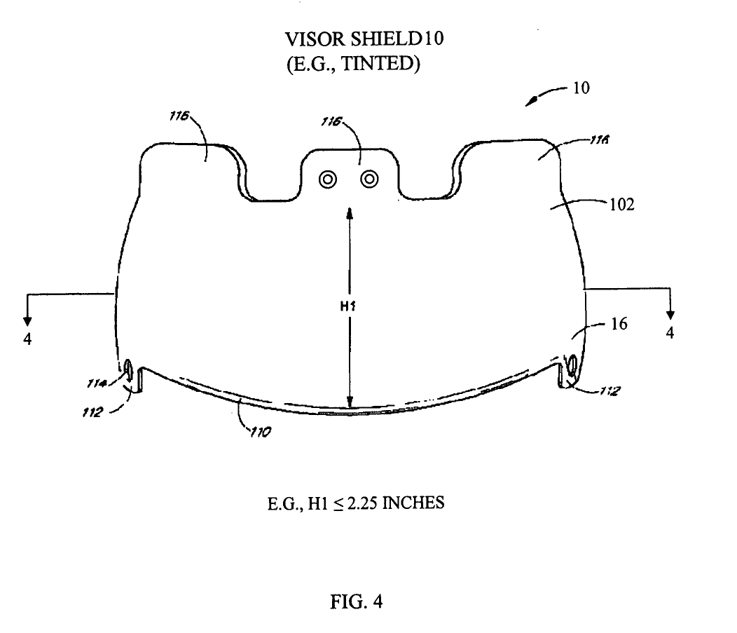

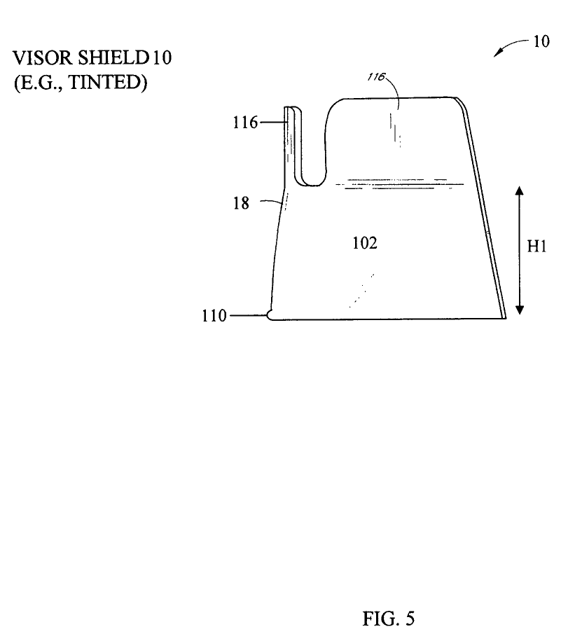

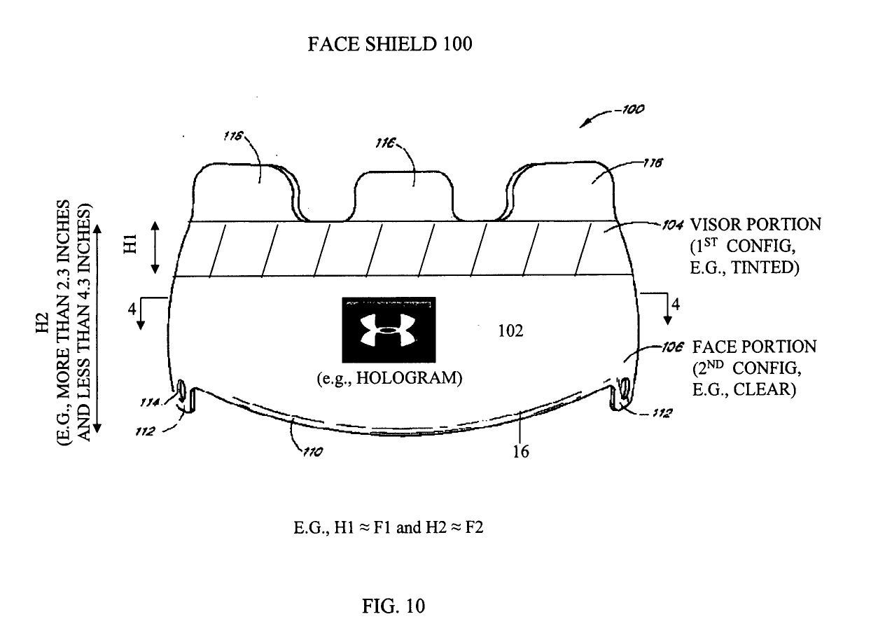

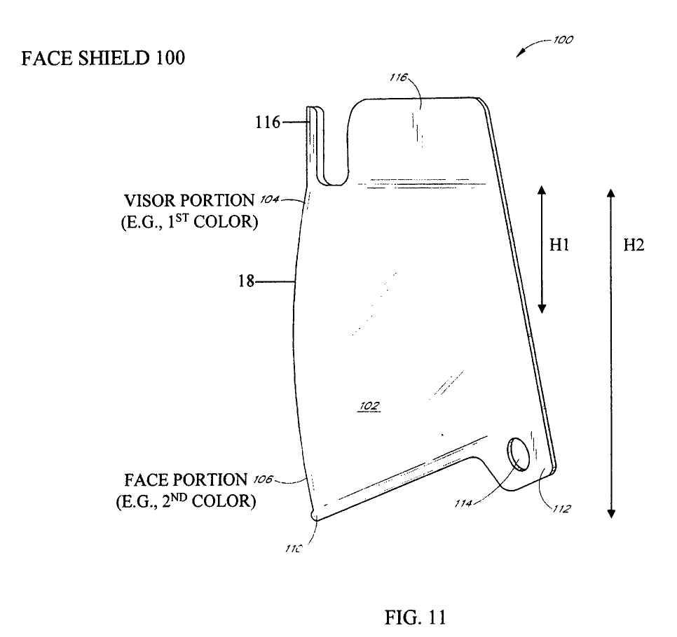

The lens 102 may include a horizontal curvature 16 (see FIGS. 4 and 10) and a vertical curvature 18 (see FIGS. 5 and 11). The horizontal curvature 16 may include a circular cross-section (e.g., and/or other geometry) and may approximate a semi-circle, e.g., an arc of about 180°. The vertical curvature 18 may also include a circular cross-section (e.g., and/or other geometry).

FIGS. 2 and 6-8 illustrate the visor shield 10 that provides a (sun and/or stadium) light guard and includes a bottom portion of the lens 102 extending away from a forehead of a wearer relative to a top portion of the lens 102. The lens 102 of the visor shield 10 may be configured to allow the wearer to see objects through the lens and also without the lens, e.g., with the naked eye. The visor shield 10 may be configured to (i) be located outside of a field of vision when the head of a wearer is in an upright position and (ii) extend into the field of vision when the head of the wearer is in a tilted forward position in relation to the upright position. The shield 10 may shade the eyes of the wearer when the head of the wearer is at least one of (i) in the upright position and (ii) in the tilted forward position.

FIGS. 12A and 12B illustrate the face shield 100 that protects and covers the face of a wearer and allows the wearer to view the environment through a single wrap-around window. The face shield 100 may include a portion that extends about a substantial portion of the wearer's potential field of view. The potential field of view may be substantially greater than the actual view of any moment, and may include the extremes at each side that become visible as the wearer rotates his eyes without re-orienting his or her head. The vertical curvature 18 may include a bottom portion that extends relatively inwardly towards the face of the wearer relative to an intermediate portion of the lens 102. The face shield 100 may include a wrap-around configuration of the lens 102 in both the horizontal and vertical directions, providing a single view pane through which the wearer observes the external environment. This configuration allows the wearer to observe objects at any location through the lens 102 without requiring the wearer to change viewing environments, for example, view one object through the lens and another object at a different location outside of the view frame of the lens.

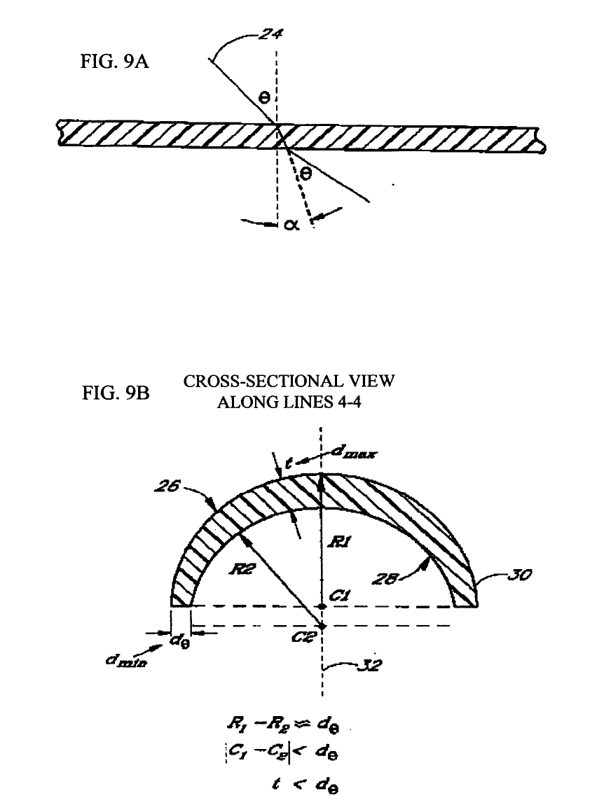

Light rays striking a plano lens at a selected angle Θ emerge from the lens at the angle Θ but offset by a selected displacement α determinable by known formulae, as illustrated in FIG. 9A. For example, a light ray 24 that impinges upon the lens is offset the distance α, which is dependent upon the lens thickness, the angle of incidence and the refractive index of the lens material. The light ray 24 exits the lens at the angle of incidence Θ. These variations in the refraction of light introduce distortions into the field of view, particularly when viewing objects along a sight line that intersects the window obliquely. Thus, an object located at or near the periphery of the field of view may appear elongated and/or shifted in space relative to the actual spatial location of the object. This phenomena represents a common problem with conventional impact resistant shields. Since the shields must be sufficiently thick to attain strength, they necessarily introduce distortion effects.

Each curvature 16 and 18 of the lens 102 may define an arc of a circle having a substantially uniform radius. This dual-curvature configuration provides a viewing window that is oriented almost normal to the line of sight as the wearer's eyes rotate to view objects. It may produce nominal levels of distortion, reducing the prism effects, e.g., non-uniform distortions of the field, created by the lens 102, and may provide an optically corrected viewing window. The radius of the horizontal curvature 16 may be in the range between about 3.25 inches and about 5.25 inches such as, for example, about 4 inches. The radius of the vertical curvature 18 may be in the range between about 6.35 inches and about 8.35 inches such as, for example, about 7.4 inches. The foregoing radius dimensions represent the distance from arbitrary center of curvature points to the arc defined by each curvature of the shield 10, 100. This construction may provide a uniform distance to allow an unobstructed viewing hemisphere.

The lens 102 of the shield 10, 100 may include a thickness defined between outer and inner surfaces, and may be defined as having a single radius when it has constant thickness. FIG. 9B illustrates a cross-sectional view of the shield 10, 100 taken along line 4-4. The lens 102 has a thickness or depth dimension d_{Θ} along its entire arc length, which is defined between an outer facing (convex) surface 26 having a radius R1 and an inner facing (concave) surface 28 having a radius R2. The radius R2 may be less than the radius R1 and eccentric relative thereto. The surfaces 26 and 28 may have different radii of curvatures about centers that are shifted relative to each other. This eccentricity shifts one surface with respect to the other, to create a curved lens that has a thickness d_{Θ} that varies monotonically away from a center point, e.g., is tapered toward the edge, along the arc length of the shield 10, 100. The inner concave surface 28 may not be completely circular, but rather one surface at least is non-diametral to produce a minimum thickness dₘᵢₙ at the edges 30 of the shield 10, 100. The diametral lines of the two surfaces are shifted such that the rear surface is moved back from a concentric position, thickening the central portion of the lens to produce a maximum thickness dₘₐₓ at or near centerline 32. The distance between the center point C1 for radius R1 and the center point C2 for radius R2 may be between 1 and 2 mm, but this distance can vary depending upon the desired thickness of the shield 10, 100 at the center or at the edges of the lens 102 in order to achieve a particular degree of bending, breaking, tensile and/or impact strength. The absolute value of the difference in center points, for example, may be less than the lens thickness d_{Θ}.

As set forth above, plano (or constant-thickness) lenses introduce distortions or prismatic deviations into the field of view of the wearer by non-uniformly shifting light entering and exiting the lens. Lenses having truly concentric inner and outer radii, e.g., a plano lens bent into a circular shape, introduce prismatic deviations. This prism effect distorts, e.g., elongates or displaces, objects viewed by the wearer and this distortion is particularly exaggerated at the peripheral viewing regions of the lens.

The variable thickness d_{Θ} and the thinning effect of the lens 102 at the edge regions 30, optically corrects the lens at the peripheral regions by reducing the occurrence of prismatic deviations and overall prism imbalance. The lensing effect of the lens 102 in conjunction with the relatively thinner edge regions 30 introduce relatively low levels of distortion and serve to optically correct the view over substantially the entire lens area. The term “optically-correct” as used herein may refer to the reduction in prismatic deviations created by the design and geometry of the shield 10, 100, and may include a shield that exhibits a relatively low dioptric power and a relatively low prism power over a portion of the wearer's field of view. The shields may include a few hundredths of a diopter of controlled dioptric power, and a negative lensing effect that compensates for the prism aberrations. Also, the front and rear curved surfaces may be shifted to achieve a structural thickening in a central region of low distortion, allowing a lower prism thickness to be safely employed peripherally.

The shield 10, 100 may include an outer radius R1 that ranges between about 95 mm and about 110 mm such as, for example, about 103 mm, and the radius R2 ranges between about 96 mm and about 103 mm such as, for example, 101 mm. For the vertical curvature of the lens 102, R1 may range between about 180 mm and 192 mm such as, for example, about 187 mm, and R2 may range between about 178 mm and about 186 mm such as, for example, about 183 mm.

The shield 10, 100 has a height H1, H2 that varies (e.g., and/or not) about the length of the viewing window in the horizontal direction (see, for example, FIGS. 5 and 11). The height H1 may be less than about at least one of 2.25 inches, 2 inches, 1.75 inches, 1.5 inches, 1.25 inches, 1 inch, 0.75 inch and 0.5 inch. The height H1, for example, may be less than 2.25 inches around the center portion of the viewing window. The height H2 may vary between about 2.3 inches and about 4.3 inches such as, for example, about 3.3 inches at the center.

The face mask 122 may also have a height F1 and a height F2 that varies (e.g., and/or not) about the length of the face mask in the horizontal direction. The height F1 may be less than about 2.25 inches, and the height H2 may be more than 2.3 inches such as, for example, vary between about 2.3 inches and about 5 inches. For example, H1 may equal about F1, and H2 may equal about F2. Also, H1 may be larger than F1, and H2 may be larger than F2. The height F1, F2 may be as illustrated by FIGS. 1-3, 6-8, 12A and 15A.

The shield 10, 100 may include tabs 112 (e.g., down, up and/or side-wardly projecting tabs) that may include mounting apertures 114 that extend therethrough. The shield 10, 100 may also include protrusions 116, 117, 118 (e.g., up, down and/or side-wardly projecting mounting protrusions), which may include advertisements, as illustrated by FIGS. 2, 6-8 and 12-14. The protrusions 116, 117, 118 may be configured to include one or more different optics (e.g., a portion of the lens 102 and/or the plano lens), shapes and/or orientations, and turned into a plurality of different (e.g., mobile) billboards. For example, one or more of the protrusions 116, 117, 118 may be auctioned as advertisement space to be shown during a televised sports event such as, for example, a football game (e.g., a college football bowl game).

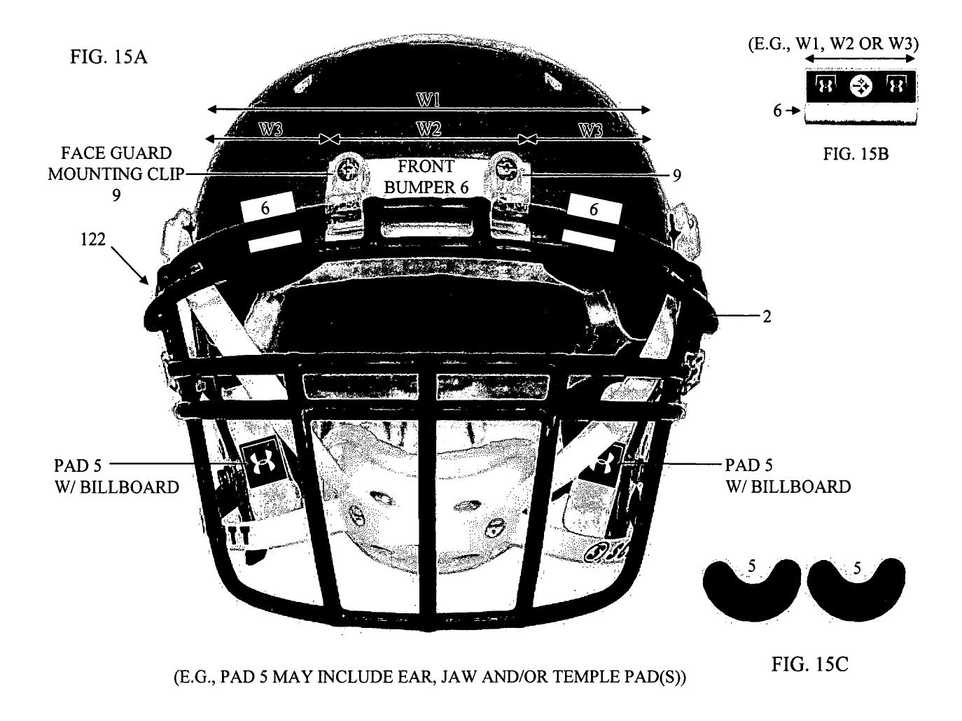

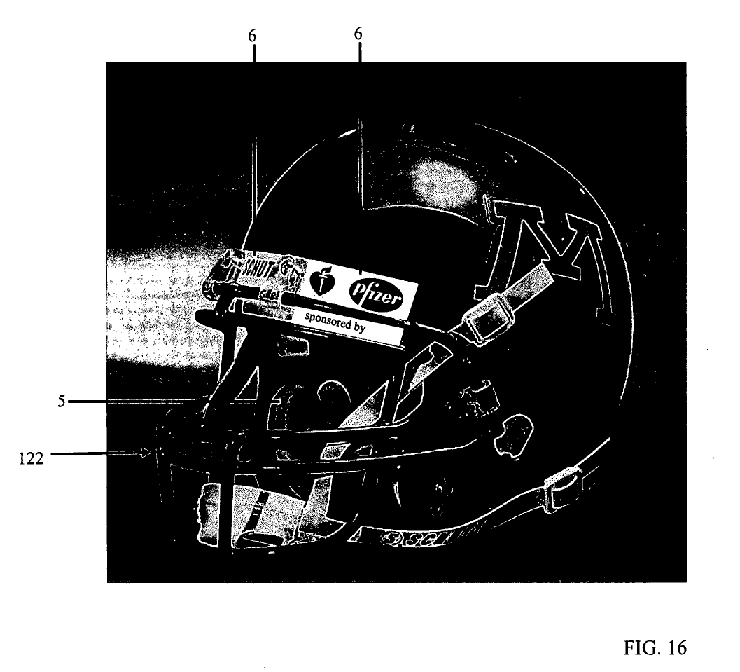

The shield 10, 100 may be integral and/or attachable to the face mask and/or the helmet. The shield 10, 100 may be fixed and/or rotatable with respect to the face mask and/or the helmet. The shield 10, 100 may be mounted to the head of the wearer and/or to various helmets, for example, by known retention mechanisms. For example, the shield 10, 100 may be attached to the face mask 122 and/or the football helmet 120 (and/or other helmets) by way of securing and mounting pins, hooks, straps, snap-fits, screws, adhesives, interlocking structures and/or other retention elements. The shield 10, 100 may be secured to the face mask 122 of the helmet 120 by a set of T-bolts and nuts, and a top portion of the shield 10, 100 may be wedged between a top of the face mask 122 and the helmet 120, for example, as illustrated by FIGS. 2 and 12A. The shield 10, 100 may also be wedged between the top of the face mask and one or more bumper(s) (e.g., a nose front bumper 6, a first side front bumper 6 and/or a second side front bumper 6, for example, which are illustrated by FIGS. 15 and 16) mounted to the helmet 120. In addition, the shield 10, 100 may fit within gaskets inside annular recesses of the face mask 122 and/or other retention systems (e.g., a goggle and/or a swim mask) to secure the shield 10, 100 to the face mask 122 and/or other retention systems.

When mounted on the helmet, the visor shield 10 may surround an upper portion of the face as illustrated by FIGS. 1-8. The shield 10 may surround a portion of the face such that a portion of the wearer's field of view may be normal to the inside surface of the lens 102 of the shield 10. Additionally, the shield 10 may extend in the vertical direction a distance sufficient to cover a portion of the upward field of view. For example, the bottom portion of the shield 10 may extend away from the wearer's face to allow the wearer to view an external environment through the lens 102 when the head is in a tilted forward position and/or is in an upright position.

On the other hand, when mounted on the helmet, the face shield 100 may surround a substantial portion of the wearer's face, including the upper portion of the face as well as the nose and portions of the cheeks, as illustrated by FIGS. 1, 3 and 10-12. The shield 100 surrounds the face such that the inside surface of the lens 102 is substantially non-oblique relative to the wearer's face and the wearer's field of view is substantially normal to the inside surface of the lens 102 of the shield 100 about most of the field of view. Additionally, the shield 100 extends in the vertical direction a distance sufficient to include a substantial portion of the downward field of view. For example, the bottom portion of the shield 100 extends inwardly towards the wearer's face to allow the wearer to view the external environment through the lens 102 at close distances, and through a contour which reduces obliqueness of incident rays. The shield 100 also extends about the face in the horizontal direction a distance sufficient to include at least a substantial portion of the field of view of the wearer.

The shield 10, 100 may include a transparent impact resistant material, such as polycarbonate, which may include a refractive index of 1.586 at the helium d line. The shield 10, 100 may be configured to meet selected strength and impact tests such as, for example, the Canadian impact testing standard CSA § 5.3.4. The shield 10, 100 may also be made of other suitable polymer materials. The shield 10, 100 may provide an optically correct shield that withstands the impact of foreign bodies, for example, without cracking or breaking. The shield 10, 100 may provide UV filtering.

The shields 10, 100 can be made from known processes and techniques, such as injection molding and/or cutting a shield out of a material (e.g., plastic) and bent over a form. The shield 10, 100 may be injection molded from impact-resistance PLUTONITE®, a material that may block UV and/or harmful blue light. The shield 10, 100 may be treated with AFR, a formulated anti-fog and scratch-resistance coating for clarity and durability.

The visor shield 10 and the face shield 100 may include a lens 102 with shapes and orientations as illustrated by FIGS. 1-14, and/or other different shapes and orientations. The shield 10, 100 may reduce optical distortion, and may have relatively high optical clarity and resolution. The shield 10, 100 may reduce eye strain, and may be relatively strong and durable and relatively lightweight. The lens 102 may include a thickness tapered to reduce prismatic distortion through the shield 10, 100, relative to an uncorrected lens with uniform thickness, and may also include a curved configuration.

The shield 10, 100 may be mounted on plastic and/or metal face masks (e.g., cages), and used with football helmets and/or other sports helmets (e.g., motocross, auto racing, hockey, lacrosse, rugby, equestrian sports, baseball (e.g., batter's helmet, catcher's helmet, etc.), softball, kayaking, skiing, snowboarding, bicycling, skateboard, roller skating, in-line skating, cricket, bull riding, etc.). For example, the shield 10, 100 can be used by individuals for recreational and sporting activities such as, for example, football, hockey, skiing, roller-blading, soccer, basketball, baseball, lacrosse and other activities. The shield 10, 100 can also be employed in other industries (e.g., that use riot helmets) by amateurs and/or professionals such as, for example, by carpenters and medical personnel.

The lens 102 may include a spherical outer 26 and/or inner 28 surfaces (e.g., which conform substantially to a surface of a sphere) and/or other surface geometries such as, for example, toroidal (e.g., which conform to a surface of a toroid). Other geometries of the lens 102 may include elliptical and/or aspheric. The shield 10, 100 may be tapered from a relatively thick point within a body of the shield to relatively thinner portions around peripheral edges of the shield. The lens 102 may also include one or more features, for example, as described by U.S. Pat. No. 6,010,217, which is hereby incorporated by reference.

The shield 10, 100 may address optical and/or mechanical concerns. For example, the variable thickness, e.g., the thinning effect of the lens 102 at the edges, optically corrects the lens at the peripheral regions by reducing the occurrence of prismatic deviations and overall prism imbalance. Also, the shield 10, 100 has a thickness effective to survive impact without cracking, and curves in both horizontal and vertical planes over substantially the lens 102 to introduce a degree of lensing and correct viewing aberrations.

The shield 10, 100, however, may become, in part or in whole, muddy, smeared, blurry (e.g., with sweat and/or water), scratched and/or otherwise damaged. Disposable lenses 202 (e.g., tear-off lenses) may thus be attached (e.g., removably overlaid) to the outer 26 and/or inner 28 surfaces of the shield 10, 100, including the lens 102 (e.g., the visor portion 104 and/or the face portion 106) and/or the protrusions 116, 117, 118 (e.g., with billboards), to maintain, for example, suitable visibility through the lens 102 and/or the protrusions 116, 117, 118. The disposable lenses 202 may be provided in stacked relationship on a (e.g., inner and/or outer) surface of the shield 10, 100 and torn or peeled away successively as the lenses become splattered with mud, sweat and/or otherwise damaged to be discarded. The disposable lens(es) of the stack may be removably mounted with respect to each other and with respect to the lens 102 and/or protrusions 116, 117, 118. Each disposable lens may be provided with a tab to facilitate removal of a top disposable lens from the stack without unintentional removal of other disposable lenses of the stack. A disposable lens(es) may include a bendable body (e.g., which may be transparent, translucent, etc.) that conforms to one or more portions (e.g., the outer 26 and/or inner 28 surfaces and/or the visor 104 and/or face 106 portions) of the shield 10, 100, as well as one or more tabs to allow the wearer to grasp the tabs and tear off the disposable lens(es), for example, when damaged and/or while the shield 10, 100 is being worm. The disposable lenses may be anti-glare, and/or tinted, clear and/or other color. For example, a first disposable lens 202 of a stack may be a first color (e.g., tinted) and mounted to a second disposable lens 202 of the stack that may be a second color (e.g., clear)—or vice versa. The disposable lenses may also include one or more features, for example, as described in U.S. Pat. Nos. 6,870,686; 6,085,358; 5,592,698; 4,076,373; and/or 3,945,044, all of which are hereby incorporated by reference. The disposable lenses may also be configured as stacked pealable and/or disposable billboards, for example, with tabs.

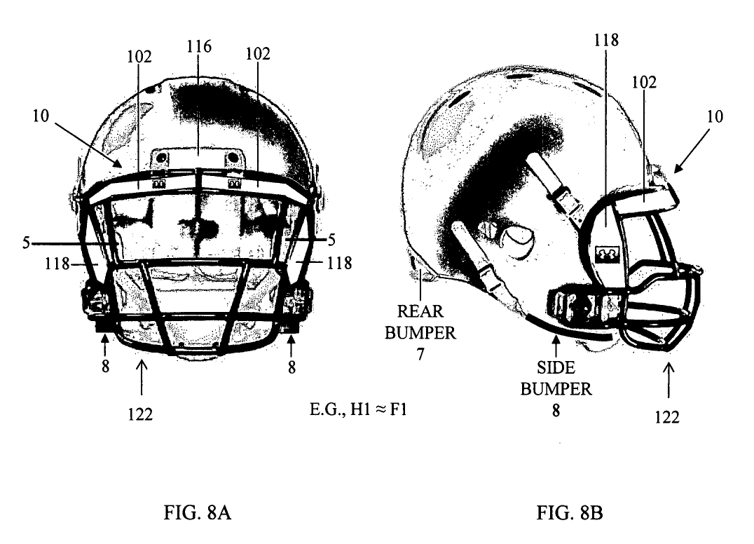

A pad 5 may be an ear, jaw and/or temple pad(s). The pad 5 may provide protection for the jaw area, for example, as illustrated by FIGS. 8A and 15C and U.S. Pat. No. D492,818. A billboard may be mounted to the pad 5 (e.g., a front, back and/or bottom face(s) of the pad 5 that may be curved) to turn the pad 5 into a (e.g., mobile) billboard to be viewed by spectators, for example, as illustrated by FIG. 15A. The pad 5 may be configured to be mounted on a headgear, including a football helmet, a hockey helmet, a catcher's helmet, a baseball batting helmet, etc. The pad 5 may be formed of a resilient material having a uniform thickness, and may be curve and/or non-curve shaped (e.g., U-shaped). Female snaps may be secured to a side face(s) of the pad 5 to engage male snaps secured to an earflap of the headgear to protect a hinge area of a wearer's jaw. The pad 5 may be used on a left side and/or a right side of the headgear. The pad 5 may include one or more features, for example, as described in U.S. Pat. Nos. 6,934,971; 6,370,699; 4,831,668 and/or D492,818, all of which are hereby incorporated by reference.

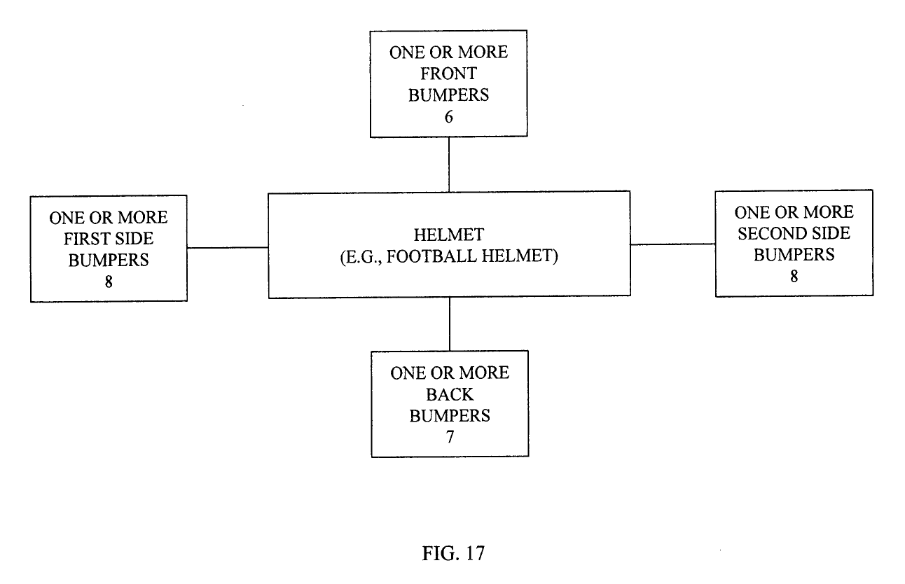

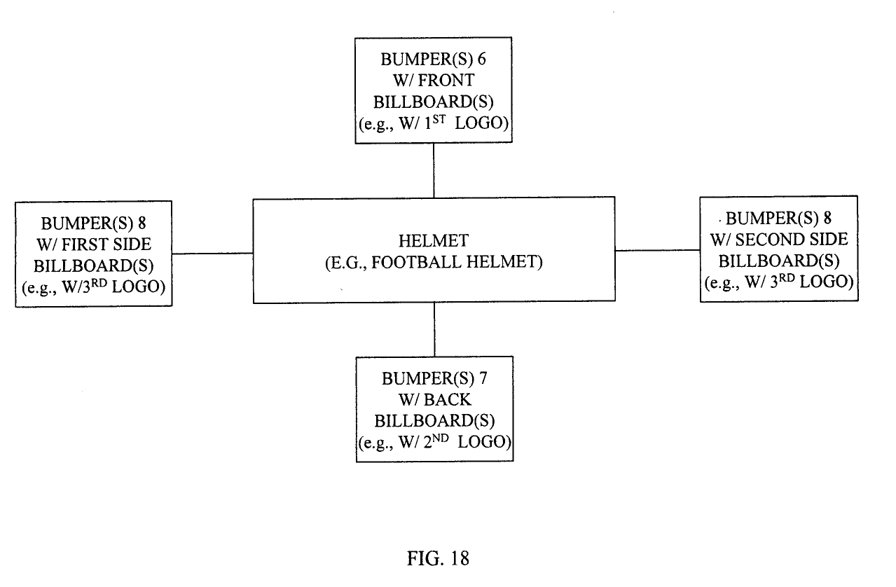

A front bumper(s) 6 (e.g., a nose front bumper, a first side front bumper, a second side front bumper, etc.), a back bumper(s) 7 (e.g., a central neck bumper, a first side neck bumper, a second side neck bumper, etc.) and/or a plurality of side bumper(s) 8, for example, may be placed on edges of the helmet. FIGS. 1, 2, 6-8, 12 and 15-18 illustrate examples of the bumpers 6, 7, 8, which may be configured to include one or more billboard(s) (e.g., with decals, green screens, etc.). The side front bumper(s) 6, for example, may be shaped to resemble side protrusions 116, which are illustrated in FIG. 2 with a Pepsi logo and a Oakley logo. The nose front bumper 6, for example, may be shaped as illustrated in FIGS. 1, 2 and 15. The bumpers 6, 7, 8 may be wrap-around and/or non-wrap around bumpers, and may be made of a resilient material. The bumpers 6, 7, 8 may be configured for football helmets and/or other sports helmets, including a catcher's helmet, a hockey helmet, etc. The bumpers 6, 7, 8 may include one or more features, for example, as described in U.S. Pat. Nos. 4,566,137 and/or 4,023,213, all of which are hereby incorporated by reference.

The shield 10, 100 and/or other gear may provide an optical illusion (e.g., three dimensional advertisements), for example, with holographic lenses that may create a visual spectacle and a lasting impression. The lens 102 and/or the protrusions 116, 117 and/or 118 may include a hologram film such that the wearer, for example, may see clearly through the lens while on lookers may see a holographic image. The shield 10, 100 may include one or more features, for example, as described in U.S. Pat. Nos. 5,892,600; 5,432,623; 5,103,323; 4,934,792 and/or 4,315,665, all of which are hereby incorporated by reference.

Chromakeying may be used with a marketing program utilizing a billboard(s). The billboard(s) may include a colored background material (e.g., a so-called green screen) for computer generated imagery (CGI) and/or digital media, for example, for eye-catching, eye-popping imagery. The background material to be used may depend upon an effects artists and/or the needs of a specific marketing program. The background material (e.g., a chromakey color screen) may be green, blue, orange, yellow, grey, etc. The billboard(s) may include a canvas (e.g., a solid fabric screen) for computer-generated imagery to be added to the billboard(s). The screen (which may not be displayed to a television audience) may be electronically replaced with a background, for example, created by one or more animation techniques such as, for example, hand-drawn, stop-motion and/or computer-generated. The television audience is then treated to the result (e.g., live action combined with animation) when the event airs. Also, the screen may also be used by photography (e.g., film, digital, etc.), digital masking, and/or video production to modify the result and/or create other effects for a different audience (e.g., a news magazine audience vs. a television audience).

The shield 10, 100 and/or other gear may also include one-way vision display panels, for example, constructed from a film material and which contain an image (e.g., a printed image) that is visible when viewed from one direction and which appears transparent when viewed from a second, opposite direction. The one-way vision display panels (e.g., self-adhesive panels) may be applied to and displayed on one or more surfaces of the shield 10, 100, including the lens 102 and/or the protrusions 116, 117 and/or 118.

The one-way vision display panels may include a perforated film (e.g., perforated vinyl film). The perforations allow vision through an image (e.g., an advertisement) itself. The perforations may be offered in various sizes. For example, the larger the perforation the better the visibility through the image. The eyes of the wearer, for example, overlooks a matrix of the film as they focus on a visible image beyond the shield 10, 100.

One or more panels may be configured to allow viewing through the panels in one direction without seeing the image, yet the image can be viewed by looking at the panel assembly from the opposite direction. The image may be suitable as an advertising medium as applied to the shield 10, 100. A helmet wearer may not see the image on the shield 10, 100 by looking outwardly through the shield 10, 100. Looking in the opposite direction, from outside to inside the shield 10, 100, a person will see the image through the panels. One-way see-thru panels and/or films allow an image to be applied and viewed from one side and, because of the perforations, substantial light passes through the film allowing the viewer relatively unobstructed vision from the opposite side.

The shield 10, 100 and/or the one-way vision display panels and/or films may include one or more features, for example, as described in U.S. Pat. Nos. 6,258,429; 5,830,529; 5,773,110; 5,609,938; 5,525,177; 4,940,622; 4,883,556; 4,673,609; 4,167,839; 4,070,781 and/or 3,451,877, all of which are hereby incorporated by reference.

A (i) bumper(s) 6, 7 and/or 8, (ii) protrusions 116, 117 and/or 118 and/or (iii) lens 102 may include (i) a first side billboard, (ii) a second side billboard and (iii) a central billboard. The first side billboard may be for a participant charitable organization(s) (e.g., and/or other organization(s) such as, for example, a school and/or a league) to include a first advertisement (e.g., first logo(s)). The central billboard may include a message such as, for example, “sponsored by.” The second side billboard may be for a participant advertiser(s) and/or sponsor(s) to include a second advertisement (e.g., second logo(s)). The second side billboard may be auctioned and/or a price negotiated, for example, to generate funds and/or awareness for the organization(s) with the first advertisement on the first side billboard and/or to generate exposure and/or brand awareness for a product(s) and/or a service(s) associated with the advertiser(s) and/or sponsor(s).

The gear such as, for example, a helmet, a shield, a chin strap, a chin pad, an eye strip(s), a front sizer, a back sizer, a front bumper(s); a back bumper(s); a side bumper(s) and/or a jaw pad(s) may be used to advertise, for example, as part of a marketing and/or fund raising program. The gear (e.g., the shields 10, 100, the bumpers 6, 7, 8, the pads 5 and/or the disposable lenses 202) may provide one or more static billboards and/or dynamic billboards (e.g., animated billboards). The billboards may be stationary and/or mobile billboards, and may provide non-targeted and/or targeted advertisements. The billboards may also create new media space and new business and advertising opportunities, without obstructing a wearer's view. The billboards may display a plurality of advertisements that, for example, cannot be zapped (e.g., by using Tivo) and/or ignored. The billboards may be mounted to one or more interior and/or exterior surfaces of the gear. The billboards may include a decal(s) and/or other structures (e.g., the green screens and/or the one-way vision display panels such as, for example, hologram film and/or perforated film). A host of companies may use the billboards to promote their products and/or services. The advertisements may be commercial and/or non-commercial, including messages, promotions, branding, public service announcements, etc. The advertisements may be visual (e.g., text and/or graphics), audio and/or audio-visual.

The billboards may be static in that the advertising image may be permanently and/or semi-permanently affixed to the gear. An advertising message of the static billboard may be physically changed by replacing and/or repairing the billboard. The dynamic billboards may be electronic billboards and/or allow the advertising message to be displayed and/or changed electronically and/or otherwise. The dynamic billboard may allow for a variety of messages to be communicated without the physical changes, for example, employed for the static billboards. The dynamic billboards also allow the use of video and/or animation technologies to display information.

An athlete(s), team(s), school(s) (e.g., high school(s), university(ies), etc.), league(s) (e.g., NCAA, NFL, etc.) and/or others (e.g., television networks) may agree to use the billboard(s), for example, mounted to the gear to provide advertisers and/or sponsors with advertising time embedded inside sports action and/or programming itself. During a sports event (e.g., NCAA BCS football game), the billboard(s) (e.g., with a logo of Under Armour) mounted on a player(s) (e.g., a starting quarterback) alone would provide more value (e.g., exposure) than a 30-second TV commercial for a company (e.g., Under Armour)—and that is just one television show. Newspapers, magazines, news programs, sports highlight shows and/or others (e.g., video games) featuring the player(s) with the billboard(s) may also yield the company more value (e.g., free advertising). Accordingly, advertisers and/or sponsors may be willing to sign deals (e.g., endorsement and/or promotional deals) with the athlete(s), team(s), school(s), league(s) and/or others to have access to the billboard(s), for example, mounted to the gear for the exposure and/or the branding.

For example, the average price for a half-minute ad in the 2005 Super Bowl game was $2.4 million, and advertisers did not blink at the price tag. By using the billboard(s), however, the potential payoff for the advertisers is greater, as they may receive more camera time (e.g., every time the helmet of the starting quarterback and/or other players is televised) for a brand and/or attract more buzz. The billboard(s) may also get a logo of a company (e.g., a potential maker and/or seller of the gear (e.g., the shield 10, 100, etc.) such as, for example, Under Armour) in front of a big TV audience, for example, without having to pay the network for a commercial.

In sum, a marketing and/or a fund raising program(s) with the gear and/or the billboard(s) may be aimed at reaching the people (e.g., the millions of people) that watch sports and/or other events to capture their attention and build brand awareness and/or loyalty. Some of the proceeds generated by the program may be donated to charity, a logo of which may also be placed on a portion of the billboard(s) for awareness of a cause of the charity.

A billboard(s) may include a first portion for a logo of a participant charitable organization, a second portion for a logo of a participant advertiser(s) and/or sponsor(s) and/or a third portion for a message such as, for example, “sponsored by,” as illustrated by FIG. 16. The billboard(s) and/or portions thereof may be auctioned and/or negotiated to generate funds, for example, for the participant charity, school(s), league(s) and/or others (e.g., athletes, television networks, etc.).

Advertising rates for the billboard(s) mounted to the gear may be based upon one or more factors such as, for example, Nielson ratings, participant league(s) (e.g., amateur, professional, etc.), participant team(s), participant player(s) (e.g., total number, popularity and/or positions), gear type(s), gear location(s), advertisement size(s), advertisement position(s) on gear(s), participant sponsors and/or advertisers, time period for marketing program and/or brand recall and/or recognition perceived value. A method to set a price on billboard inventory (e.g., available billboard space) may also be by using an auction. The method may allow advertisers and/or sponsors to create a profile and make a bid. When the auction ends, the participating advertisers and/or sponsors may be notified whether their bid won the auction.

The gear (e.g., the impact resistant shield 10, 100, the bumpers 6, 7, 8, the pads 5, the disposable lenses 202, etc.) with or without the billboard(s) can be employed in a wide range of environments and for a wide range of uses, including helmets, caps, windshields, windows and/or direct view displays such as, for example, ATM machines and/or kiosks.

The foregoing presentation of the described embodiments is provided to enable any person skilled in the art to make or use the present invention. Various modifications to these embodiments are possible, and the generic principles presented herein may be applied to other embodiments as well. As such, the present invention is not intended to be limited to the embodiments shown above, and/or any particular configuration of structure but rather is to be accorded the widest scope consistent with the principles and features disclosed in any fashion herein.

What is claimed is:

1. A method comprising:
providing a sports helmet shield;
generating funds for at least an organization by at least allowing one or more advertisers to turn the sports helmet shield into one or more mobile billboards.

2. The method of claim 1, wherein the organization is a charity.

3. The method of claim 1, wherein the organization is a university.

4. The method of claim 1, wherein the sports helmet shield is a visor shield.

5. The method of claim 1, wherein the sports helmet shield is a face shield.

6. The method of claim 1, wherein a stack of disposable lenses is mounted to at least one of (i) an inner surface of the sports helmet shield and (ii) an outer surface of the sports helmet shield.

7. The method of claim 6, wherein the sports helmet shield is mounted to a football helmet.

8. The method of claim 6, wherein the inner surface and the outer surface have different radii of surface curvature.

9. The method of claim 1, wherein the one or more mobile billboards includes a see-through billboard configured to be visible when viewed from one direction and which is transparent when viewed from a second, opposite direction.

10. The method of claim 1, wherein the one or more mobile billboards includes animation.

11. The method of claim 1, wherein the sports helmet shield is a curved unitary lens with a variable thickness.

12. An apparatus comprising:
a helmet; and
a visor shield mounted to the helmet and configured to include a viewing window,
wherein the viewing window includes (i) in a first orientation, a first curvature extending in a horizontal direction and a second curvature extending in a vertical direction, (ii) a variable thickness to reduce distortions in a field of view and (iii) a height of less than 2.25 inches around a center portion of the viewing window.

13. The apparatus of claim 12, wherein the height is less than one of (i) 2 inches, (ii) 1.75 inches, (iii) 1.5 inches, (iv) 1.25 inches, (v) 1 inch, (vi) 0.75 inch and (vii) 0.5 inch.

14. The apparatus of claim 12, wherein the visor shield also includes one or more advertisement windows.

15. The apparatus of claim 12, wherein the thickness of the visor shield varies monotonically away from a center point of the viewing window.

16. The apparatus of claim 12, wherein the visor shield includes polycarbonate.

17. The apparatus of claim 12, wherein the visor shield includes a circumferential bead.
